(19) United States
(12) Patent Application Publication
(10) Pub. No.: US 2017/0244104 A1
(43) Pub. Date: Aug. 24, 2017

(54) CATHODE ACTIVE MATERIAL AND BATTERY

(71) Applicant: Panasonic Intellectual Property Management Co., Ltd., Osaka (JP)

(72) Inventors: RYUICHI NATSUI, Osaka (JP); ISSEI IKEUCHI, Hyogo (JP); KENSUKE NAKURA, Osaka (JP)

(21) Appl. No.: 15/406,825

(22) Filed: Jan. 16, 2017

(30) Foreign Application Priority Data
Feb. 19, 2016 (JP) 2016-029413

(51) Int. Cl. H01M 4/525; H01M 10/0525; H01M 4/505

(52) U.S. Cl. CPC H01M 4/525; H01M 4/505; H01M 10/0525; H01M 2004/028

(57) ABSTRACT

A cathode active material contains a compound having a crystal structure of space group FM-3M, represented by composition formula (1), and having a half-width in 2δ of 0.9° or more and 2.4° or less for a (200) diffraction peak in powder X-ray diffraction (XRD): LiₓMe_{y}O₂. . . (1). In the formula, Me represents one or two or more elements selected from the group consisting of Mn, Nb, Ti, Ni, Co, Fe, Sn, Cu, Mo, Bi, V, and Cr. In addition to this, the following conditions are met: 0.5≦x/y≦3.0; and 1.5≦x+y≦2.3.

### BACKGROUND

1. Technical Field

The present disclosure relates to a cathode active material for batteries and to a battery.

2. Description of the Related Art

International Publication No. 2014/156153 discloses a cathode active material having a crystal structure of space group FM-3M and represented by a formula Li₁₋ₓNb_{y}Me_{z}AₚO₂ (where Me represents one or more transition metals including Fe and/or Mn, 0<x<1, 0<y <0.5, 0.25≦z<1, A represents any element other than Nb and Me, and 0≦ p≦0.2).

### SUMMARY

In the related art, there is a need for high-capacity batteries.

In one general aspect, the techniques disclosed here feature a cathode active material. The cathode active material contains a compound having a crystal structure of space group FM-3M, represented by composition formula (1), and having a half-width in 2θ of 0.9° or more and 2.4° or less for a (200) diffraction peak in powder X-ray diffraction (XRD): LiₓMe_{y}O₂. . . (1). In the formula, Me represents one or two or more elements selected from the group consisting of Mn, Nb, Ti, Ni, Co, Fe, Sn, Cu, Mo, Bi, V, and Cr. In addition to this, the following conditions are met: 0.5≦x/y≦3.0; and 1.5≦x+y≦2.3.

The present disclosure provides a high-capacity battery.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional diagram that illustrates a schematic configuration of a battery as an example of a battery according to Embodiment 2; and

FIG. 2 illustrates a powder X-ray diffraction chart of the cathode active material of Example 1.

### DETAILED DESCRIPTION

The following describes some embodiments of the present disclosure. Embodiment 1

A cathode active material according to Embodiment 1 contains a compound having a crystal structure of space group FM-3M and represented by composition formula (1).

LiₓMe_{y}O₂ (1)

In formula (1), Me represents one or two or more elements selected from the group consisting of Mn, Nb, Ti, Ni, Co, Fe, Sn, Cu, Mo, Bi, V, and Cr.

In the cathode active material according to Embodiment 1, the compound is represented by the composition formula (1) in which the following conditions are met:

0.5≦x/y≦3.0; and

1.5≦x+y≦2.3.

In addition to this, the compound has a half-width in 2θ of 0.9° or more and 2.4° or less for the (200) diffraction peak in powder X-ray diffraction (XRD).

This configuration provides a high-capacity battery.

A lithium-ion battery, for example, that uses a cathode active material containing such a compound has a redox potential (vs. L/Li⁺) of approximately 3.3 V.

When the half-width in 2θ for the (200) diffraction peak in XRD is less than 0.9°, regular arrangement of Li and Me in the compound makes the formation of percolation paths for Li insufficient. In such a case, the capacity is insufficient.

When the half-width in 2θ for the (200) diffraction peak in XRD is more than 2.4°, the crystal structure of the compound is so unstable that the removal of Li during charging destroys it. In such a case, the capacity is insufficient.

When x/y in composition formula (1) is less than 0.5, the availability of Li in the compound is low, and paths for the diffusion of Li are inhibited. In such a case, the capacity is insufficient.

When x/y in composition formula (1) is more than 3.0, removing Li for charging makes the crystal structure of the compound unstable, resulting in lower efficiency in the insertion of Li for discharge. In such a case, the capacity is insufficient.

When x+y in composition formula (1) is less than 1.5, phase separation occurs during the synthesis of the compound, resulting in large amounts of impurities being formed. In such a case, the capacity is insufficient.

When x+y in composition formula (1) is more than 2.3, the compound has an anion-deficient structure. Removing Li for charging makes the crystal structure of the compound unstable, resulting in lower efficiency in the insertion of Li for discharge. In such a case, the capacity is insufficient.

In the compound represented by composition formula (1), Li and Me are considered located at the same site in a random manner.

The compound represented by composition formula (1) therefore allows Li ions to percolate therethrough.

As a result, the cathode active material according to Embodiment 1 is suitable for providing a high-capacity lithium-ion battery.

In the cathode active material according to Embodiment 1, Me can be one element selected from the group consisting of Mn, Nb, Ti, Ni, Co, Fe, Sn, Cu, Mo, Bi, V, and Cr.

Alternatively, in the cathode active material according to Embodiment 1, Me can be a solid solution containing two or more elements selected from the group consisting of Mn, Nb, Ti, Ni, Co, Fe, Sn, Cu, Mo, Bi, V, and Cr.

In the cathode active material according to Embodiment 1, some Li atoms in the LiₓMe_{y}O₂ may be replaced with atoms of an alkali metal, such as Na or K.

The cathode active material according to Embodiment 1 may contain the compound as its main component.

In other words, the amount of the compound in the cathode active material according to Embodiment 1 may be 50% by weight or more.

This configuration provides a battery with a higher capacity.

The cathode active material according to Embodiment 1, when containing the compound as its main component, may further contain inevitable impurities or substances other than the main component. Such substances include starting materials for the synthesis of the compound, by-products of the synthesis of the compound, and decomposition products of the compound.

In the cathode active material according to Embodiment 1, the amount of the compound may be, for example, 90% by weight to 100% by weight excluding inevitable impurities.

This configuration provides a battery with a higher capacity.

In the cathode active material according to Embodiment 1, Me may include Mn.

In other words, Me may be Mn. Alternatively, Me can be a solid solution containing Mn and one element selected from the group consisting of Nb, Ti, Ni, Co, Fe, Sn, Cu, Mo, Bi, V, and Cr.

This configuration provides a battery with a higher capacity.

In the cathode active material according to Embodiment 1, the compound may have a half-width in 2θ of 1.5° or more and 2.2° or less for the (200) diffraction peak in XRD.

This configuration provides a battery with a higher capacity.

In the cathode active material according to Embodiment 1, the compound may have a composition formula (1) in which 1.5≦x/y≦2.0.

This configuration provides a battery with a higher capacity.

In the cathode active material according to Embodiment 1, the compound may have a composition formula (1) in which 1.9≦x+y≦2.0.

This configuration provides a battery with a higher capacity. Process for the Production of the Compound

The following describes an example of a process for producing this compound as a component of the cathode active material according to Embodiment 1.

The compound of composition formula (1) can be produced by, for example, the following method.

A material containing Li, a material containing O, and a material containing Me are prepared. Examples of Li-containing materials include oxides such as Li₂O and Li₂O₂, salts such as Li₂CO₃ and LiOH, and lithium-transition metal oxides such as LiMeO₂ and LiMe₂O₄. Examples of Me-containing materials include oxides in various oxidation states such as Me₂O₃, salts such as MeCO₃ and MeNO₃, hydroxides such as Me(OH)₂ and MeOOH, and lithium-transition metal oxides such as LiMeO₂ and LiMe₂O₄. For example, when Me is Mn, examples of Mn-containing materials include manganese oxides in various oxidation states such as Mn₂O₃, salts such as MnCO₃ and MnNO₃, hydroxides such as Mn(OH)₂ and MnOOH, and lithium-transition metal oxides such as LiMnO₂ and LiMn₂O₄.

The materials are weighed out in a ratio by mole as specified under composition formula (1).

Through this, it is possible to change “x and y” in composition formula (1) within the ranges specified under the conditions which are met in the composition formula (1).

The materials are then mixed through, for example, a wet process or a dry process and allowed to mechanochemically react for at least 10 hours to give a compound of composition formula (1). This can be performed using, for example, a mixer such as a ball mill.

By selecting appropriate starting materials and adjusting the conditions under which the starting materials are mixed, it is possible to obtain the compound of composition formula (1) substantially without any by-product.

The use of a lithium-transition metal oxide as a precursor further reduces the energy for the mixing of the elements. This gives the compound of composition formula (1) a higher purity.

The composition of the resulting compound of composition formula (1) can be determined by, for example, ICP emission spectrometry and inert gas fusion-infrared absorptiometry.

The space group of the crystal structure is then determined by XRD. In this way, the compound of composition formula (1) can be identified.

In an aspect of Embodiment 1, therefore, the process for producing a cathode active material includes (a) providing starting materials and (b) allowing the starting materials to mechanochemically react to give the cathode active material.

Step (a) may include mixing a Li-containing material and a Me-containing material in proportions such that the ratio of Li to Me by mole is 0.5 or more and 3.0 or less to prepare a mixture of the materials.

In such a case, step (a) may include producing a lithium-transition metal oxide for use as a starting material by a known method.

Step (a) may include mixing a Li-containing material and a Me-containing material in proportions such that the ratio of Li to Me by mole is 1.5 or more and 2.0 or less to prepare a mixture of the materials.

Step (b) may include allowing the starting materials to mechanochemically react using a ball mill.

As can be seen from the foregoing, the compound of composition formula (1) can be synthesized through a mechanochemical reaction of precursors (e.g., Li₂O, transition metal oxides, or lithium-transition metal composites) initiated using a planetary ball mill.

The amount of Li atoms in the finished compound can be increased by adjusting the proportions of the precursors.

By optionally adjusting the method or parameters for the reaction (mixing) of the starting material or materials, furthermore, it is possible to give the compound of composition formula (1) a predetermined half-width, in 2θ, for the (200) diffraction peak in XRD.

For example, compounds made from the same starting material(s) can exhibit different half-widths according to whether the production process includes firing in addition to the mechanochemical reaction.

### Embodiment 2

The following describes Embodiment 2. What has already been described in Embodiment 1 is omitted where appropriate.

A battery according to Embodiment 2 includes a cathode (i.e., a positive electrode), an anode (i.e., a negative electrode), and an electrolyte. The cathode contains a cathode active material according to Embodiment 1.

This configuration provides a high-capacity battery.

More specifically, as described in Embodiment 1, the cathode active material contains many Li atoms per Me atom. As a result, a high-capacity battery is provided.

The battery according to Embodiment 2 can be configured as, for example, a lithium-ion secondary battery or an all-solid-state secondary battery.

In a battery according to Embodiment 2, the cathode may have a cathode active material layer. The cathode active material layer may contain the cathode active material according to Embodiment 1 (the compound according to Embodiment 1) as its main component. (The cathode active material layer may contain 50% or more as a weight fraction to the entire layer (50% by weight or more) of the cathode active material.)

This configuration provides a battery with a higher energy density and a higher capacity.

In a battery according to Embodiment 2, the cathode active material layer may contain 70% or more as a weight fraction to the entire layer (70% by weight or more) of the cathode active material according to Embodiment 1 (the compound according to Embodiment 1).

This configuration provides a battery with a higher energy density and a higher capacity.

In a battery according to Embodiment 2, the cathode active material layer may contain 90% or more as a weight fraction to the entire layer (90% by weight or more) of the cathode active material according to Embodiment 1 (the compound according to Embodiment 1).

This configuration provides a battery with a higher energy density and a higher capacity.

In a battery according to Embodiment 2, the anode, for example, may contain an anode active material in which lithium can be stored and from which lithium can be released (e.g., an anode active material with lithium-storing and −releasing properties).

In a battery according to Embodiment 2, the electrolyte, for example, may be a nonaqueous electrolyte (e.g., a nonaqueous liquid electrolyte) or a solid electrode.

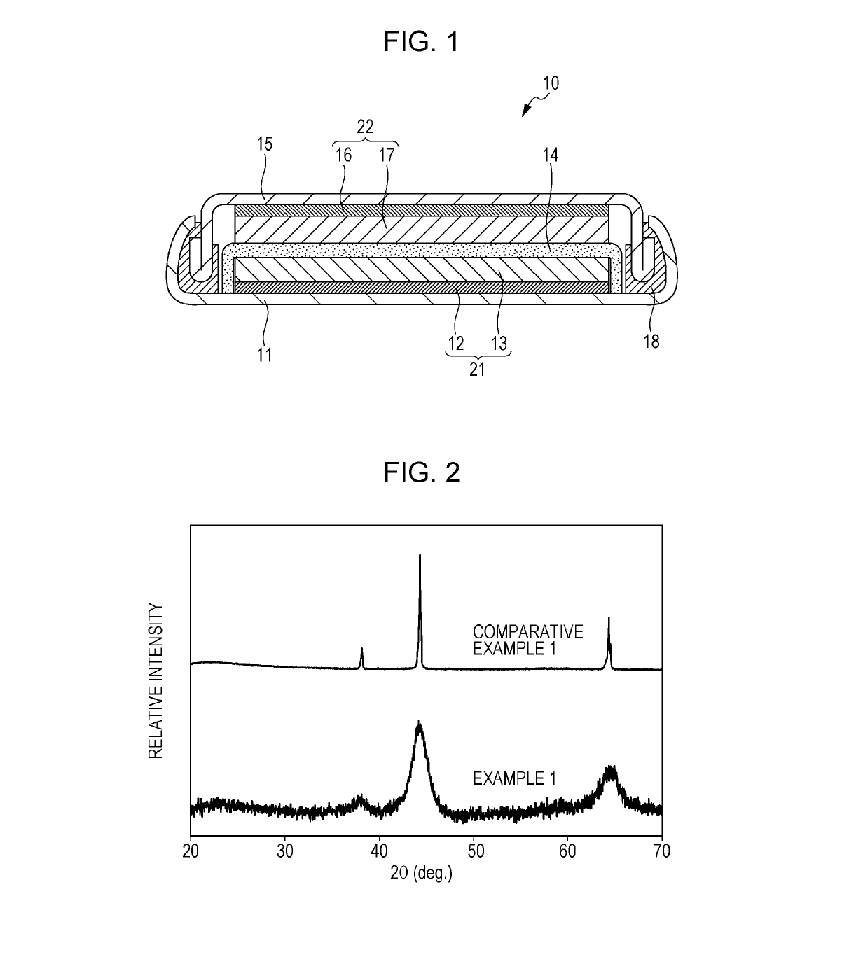

FIG. 1 is a cross-sectional diagram that illustrates a schematic configuration of a battery 10 as an example of a battery according to Embodiment 2.

As illustrated in FIG. 1, the battery 10 includes a cathode 21, an anode 22, a separator 14, a case 11, a sealing plate 15, and a gasket 18.

The separator 14 is located between the anode 21 and the cathode 22.

The cathode 21, the anode 22, and the separator 14 are impregnated with a nonaqueous electrolyte (e.g., a nonaqueous liquid electrolyte).

The cathode 21, the anode 22, and the separator 14 form an electrode group.

The electrode group is contained in the case 11.

The case 11 is closed with the gasket 18 and the sealing plate 15.

The cathode 21 includes a cathode collector 12 and a cathode active material layer 13 on the cathode collector 12.

The cathode collector 12 is made of, for example, a metallic material (e.g., aluminum, stainless steel, or an aluminum alloy).

The cathode collector 12 can be omitted and the case 11 can be used as a cathode collector.

The cathode active material layer 13 contains a cathode active material according to Embodiment 1.

The cathode active material layer 13 may optionally contain, for example, additives (e.g., a conductive agent, an ion conductor, and a binder). The cathode active material layer 13 may contain commonly known cathode active materials for secondary batteries (e.g., NCA active materials) in addition to that according to Embodiment 1.

The anode 22 includes an anode collector 16 and an anode active material layer 17 on the anode collector 16.

The anode collector 16 is made of, for example, a metallic material (e.g., aluminum, stainless steel, or an aluminum alloy).

The anode collector 16 can be omitted and the sealing plate 15 can be used as an anode collector.

The anode active material layer 17 contains an anode active material.

The anode active material layer 17 may optionally contain, for example, additives (e.g., a conductive agent, an ion conductor, and a binder).

The anode active material can be a commonly known anode active material for secondary batteries (e.g., a metallic material, a carbon material, an oxide, a nitride, a tin compound, or a silicon compound).

The metallic material can be a pure metal or an alloy. Examples of metallic materials include metallic lithium and lithium alloys.

Examples of carbon materials include natural graphite, coke, graphitizing carbon, carbon fiber, spherical carbon, artificial graphite, and amorphous carbon.

Materials preferred in terms of capacity per unit volume include silicon (Si), tin (Sn), silicon compounds, and tin compounds. The silicon compounds and the tin compounds include alloys and solid solutions.

An example of a silicon compound is SiOₓ (0.05<×<1.95). Compounds (alloys or solid solutions) obtained by replacing some silicon atoms in SiOₓ with atoms of one or more other elements can also be used. The one or more replacing elements are selected from the group consisting of boron, magnesium, nickel, titanium, molybdenum, cobalt, calcium, chromium, copper, iron, manganese, niobium, tantalum, vanadium, tungsten, zinc, carbon, nitrogen, and tin.

Examples of tin compounds include Ni₂Sn₄, Mg₂Sn, SnOₓ (0<×<2), SnO₂, and SnSiO₃. The manufacturer can use one tin compound selected from these alone. Alternatively, the manufacturer can use a combination of two or more tin compounds selected from these.

The anode active material can be in any shape. Anode active materials in known shapes (particles, fibers, and so forth) can be used.

Any method can be used to load lithium into (or make lithium occluded in) the anode active material layer 17. Specific examples of methods include (a) depositing a layer of lithium on the anode active material layer 17 using a gas-phase process such as vacuum deposition and (b) heating a foil of metallic lithium and the anode active material layer 17 with one on the other. In both methods, heat is used to diffuse lithium into the anode active material layer 17. It is also possible to use an electrochemical process to make lithium occluded in the anode active material layer 17. In a specific example, the battery is assembled using a lithium-free anode 22 and a foil of metallic lithium (the cathode), and then the battery is charged so that lithium is occluded in the anode 22.

Examples of binders that can be used in the cathode 21 and the anode 22 include polyvinylidene fluoride, polytetrafluoroethylene, polyethylene, polypropylene, aramid resins, polyamide, polyimide, polyamide-imide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyether, polyethersulfone, hexafluoropolypropylene, styrene-butadiene rubber, and carboxymethylcellulose. The binder can also be a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. Alternatively, mixtures of two or more of these binders can also be used.

Examples of conductive agents that can be used in the cathode 21 and the anode 22 include graphite, carbon blacks, conductive fibers, fluorinated graphite, metallic powders, conductive whiskers, conductive metal oxides, and organic conductive materials. Examples of forms of graphite include natural graphite and artificial graphite. Examples of carbon blacks include acetylene black, Ketjenblack®, channel black, furnace black, lamp black, and thermal black. Examples of metallic powders include an aluminum powder. Examples of conductive whiskers include zinc oxide whiskers and potassium titanium oxide whiskers. Examples of conductive metal oxides include titanium oxide. Examples of organic conductive materials include phenylenes.

The separator 14 can be a material that has a high degree of permeability to ions and a sufficiently high mechanical strength. Examples of such materials include a microporous thin film, woven fabric, and nonwoven fabric. More specifically, it is desirable that the separator 14 be made of a polyolefin such as polypropylene or polyethylene. A polyolefin-made separator 14 not only is highly durable but also provides a shutdown function when the battery is exposed to excessive heat. The thickness of the separator 14 is in the range of, for example, 10 to 300 μm (or 10 to 40 μm). The separator 14 can be a single-layer film that contains only a single material. Alternatively, the separator 14 can be a composite film (or a multilayer film) that contains two or more materials. The porosity of the separator 14 is in the range of, for example, 30% to 70% (or 35% to 60%). The term “porosity” refers to the percentage of the total volume of pores in the total volume of the separator 14. The “porosity” is measured by, for example, mercury intrusion porosimetry.

The nonaqueous liquid electrolyte contains a nonaqueous solvent and a lithium salt dissolved in the nonaqueous solvent.

Examples of nonaqueous solvents that can be used include cyclic carbonates, linear carbonates, cyclic ethers, linear ethers, cyclic esters, linear esters, and fluorinated solvents.

Examples of cyclic carbonates include ethylene carbonate, propylene carbonate, and butylene carbonate.

Examples of linear carbonates include dimethyl carbonate, ethyl methyl carbonate, and diethyl carbonate.

Examples of cyclic ethers include tetrahydrofuran, 1,4-dioxane, and 1,3-dioxolane.

Examples of linear ethers include 1,2-dimethoxyethane and 1,2-diethoxyethane.

Examples of cyclic esters include γ-butyrolactone.

Examples of linear esters include methyl acetate.

Examples of fluorinated solvents include fluoroethylene carbonate, methyl fluoropropionate, fluorobenzene, fluoroethyl methyl carbonate, fluorodimethylene carbonate, and fluoronitrile.

The manufacturer can use one nonaqueous solvent selected from these alone. Alternatively, the manufacturer can use a combination of two or more nonaqueous solvents selected from these.

The nonaqueous liquid electrolyte may contain at least one fluorinated solvent selected from the group consisting of fluoroethylene carbonate, methyl fl uoropropionate, fluorobenzene, fluoroethyl methyl carbonate, and fluorodimethylene carbonate.

Adding these fluorinated solvents to the nonaqueous liquid electrolyte will make the nonaqueous liquid electrolyte more resistant to oxidation.

The improved oxidation resistance allows the battery 10 to operate in a stable manner even when charging at a high voltage.

Examples of lithium salts that can be used include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. The manufacturer can use one lithium salt selected from these alone. Alternatively, the manufacturer can use a combination of two or more lithium salts selected from these. The concentration of the lithium salt is in the range of, for example, 0.5 to 2 mol/liter.

The solid electrolyte can be, for example, an organic polymer solid electrolyte, an oxide solid electrolyte, or a sulfide solid electrolyte.

Examples of organic polymer solid electrolytes that can be used include polymer-lithium salt complexes.

The polymer may have ethylene oxide units. Ethylene oxide units enhance ionic conductivity by allowing a greater amount of lithium salt to be contained.

Examples of oxide solid electrolytes that can be used include: NASICON solid electrolytes, typified by LiTi₂(PO₄)₃ and its substituted derivatives; (LaLi)TiO₃ perovskite solid electrolytes; LISICON solid electrolytes, typified by Li₁₄ZnGe₄O₁₆, Li₄SiO₄, LiGeO₄, and their substituted derivatives; Garnet-type solid electrolytes, typified by Li₇La₃Zr₂O₁₂ and its substituted derivatives; Li₃N and its H-substituted derivatives; and Li₃PO₄ and its N-substituted derivatives.

Examples of sulfide solid electrolytes that can be used include Li₂S-P₂S₅, Li₂S-SiS₂, Li₂S-B₂S₃, Li₂S-GeS₂, Li_{3.25}Ge_{0.25}P_{0.75}S₄, and Li₁₀GeP₂S₁₂. These may contain a dopant such as LiX (where X represents F, CI, Br, or I), MO_{P}, or Li_{q}MOₚ (where M is any of P, Si, Ge, B, Al, Ga, and In, and p and q are natural numbers).

In particular, sulfide solid electrolytes are easy to shape and highly conductive to ions. The use of a sulfide solid electrolyte therefore leads to a higher energy density of the battery.

Li₂S-P₂S₅ is electrochemically stable and has a higher ionic conductivity than other sulfide solid electrolytes. The use of Li₂S-P₂S₅ therefore leads to a higher energy density of the battery.

Batteries according to Embodiment 2 can be configured into various shapes, including coin-shaped, cylindrical, square, sheet-shaped, button-shaped, flat-plate, and multilayer batteries.

### EXAMPLES

### Example 1

### Preparation of Cathode Active Material

Li₂O, Mn₂O₃, and Nb₂O₅ were weighed out in a Li₂O/Mn₂O₃/Nb₂O₅ ratio by mole of 6/3/1.

The obtained starting materials were put into a 45-cc zirconia container with an appropriate amount of 3-mm zirconia balls, and the container was tightly sealed in an argon glove box.

The container was removed from the argon glove box, and the contents were processed in a planetary ball mill at 600 rpm for 30 hours.

The resulting compound was analyzed by powder X-ray diffraction (XRD).

The results are illustrated in FIG. 2.

The space group of this compound was FM-3M.

The half-width in 2θ for the (200) diffraction peak in XRD of the compound was 2.0°.

The compound was then analyzed for its composition by ICP emission spectrometry and inert gas fusion-infrared absorptiometry.

The composition of the compound was determined to be Li_{1.2}Mn_{0.6}Nb_{0.2}O₂. Production of Battery

Then 70 parts by mass of the compound was mixed with 20 parts by mass of a conductive agent, 10 parts by mass of polyvinylidene fluoride (PVDF), and an appropriate amount of 2-methylpyrrolidone (NMP) to give a cathode mixture slurry.

The cathode mixture slurry was applied to one side of a 20-μm thick aluminum foil cathode collector.

The applied cathode mixture slurry was dried and rolled. In this way, a 60-μm thick cathode plate was obtained with a cathode active material layer.

A 12.5-mm diameter round disk was cut out of the cathode plate for use as a cathode.

A 14.0-mm diameter round disk was cut out of a 300-μm thick foil of metallic lithium for use as an anode.

Fluoroethylene carbonate (FEC), ethylene carbonate (EC), and ethyl methyl carbonate (EMC) were mixed in a volume ratio of 1:1:6 to give a nonaqueous solvent.

LiPF₆ was dissolved in this nonaqueous solvent to a concentration of 1.0 mol/liter to give a nonaqueous liquid electrolyte.

The resulting nonaqueous liquid electrolyte was infiltrated into a separator (Celgard, LLC.; item number 2320; a thickness of 25 μm).

Celgard® 2320 is a three-layer separator that has a polypropylene layer, a polyethylene layer, and a polypropylene layer.

The cathode, anode, and separator were assembled into a CR2032 coin-shaped battery in a moisture-proof box in which the dew point was maintained at −50° C.

### Examples 2 to 5

The precursors were changed from those in Example 1.

The precursors from which the cathode active materials of Examples 2 to 5 were produced and the composition ratios of the synthesized cathode active materials are summarized in Table.

Except for this, the same procedure as in Example 1 was repeated to synthesize the cathode active materials of Examples 2 to 5.

Similar to those in Example 1, the precursors in Examples 2 to 5 were weighed out and mixed in stoichiometric amounts.

All of the compounds obtained as the cathode active materials of Examples 2 to 5 were in space group FM-3M.

Coin-shaped batteries of Examples 2 to 5 were produced using the cathode active materials of Examples 2 to 5 in the same way as in Example 1. Example 6

Li₂O₂ and LiCoO₂ were used as precursors.

The precursory materials were weighed out in a Li₂O₂/LiCoO₂ ratio by mole of 1/2.

The obtained materials were then processed in a planetary ball mill in the same way as in Example 1. This produced Li_{1.33}Co_{0.67}O₂.

The resulting compound was heated in a flow of nitrogen at 400° C. for 3 hours. In this way, the cathode active material of Example 6 was synthesized.

The compound obtained as the cathode active material of Example 6 was in space group FM-3M.

A coin-shaped battery of Example 6 was produced using the cathode active material of Example 6 in the same way as in Example 1.

### Example 7

A LiNiO₂ of space group R3-M was synthesized through a known process.

This LiNiO₂ and Li₂O₂ were used as precursors.

The precursory materials were weighed out in a Li₂O₂/LiNiO₂ ratio by mole of 1/2.

Except for this, the same procedure as in Example 6 was followed to synthesize the cathode active material of Example 7.

The compound obtained as the cathode active material of Example 7 was in space group FM-3M.

A coin-shaped battery of Example 7 was produced using the cathode active material of Example 7 in the same way as in Example 1.

### Example 8

A LiCoO₂ of space group R3-M was synthesized through a known process.

This LiCoO₂ and Li₂O₂ were used as precursors.

The precursory materials were weighed out in a Li₂O₂/LiCoO₂ ratio by mole of 1/2.

Except for this, the same procedure as in Example 1 was followed to synthesize the cathode active material of Example 8.

The compound obtained as the cathode active material of Example 8 was in space group FM-3M.

A coin-shaped battery of Example 8 was produced using the cathode active material of Example 8 in the same way as in Example 1.

### Comparative Example 1

Li₂CO₃, Mn₂O₃, and Nb₂O₅ were weighed out in a Li₂CO₃/Mn₂O₃/Nb₂O₅ ratio by mole of 0.6/0.3/0.1.

The obtained starting materials were put into a 45-cc zirconia container with an appropriate amount of 3-mm zirconia balls and ethanol, and the container was tightly sealed in an argon glove box.

The container was removed from the argon glove box, and the contents were processed in a planetary ball mill at 300 rpm for 10 hours.

The resulting mixture was fired in a flow of argon at 950° C. for 10 hours to give a cathode active material.

The resulting compound was analyzed by XRD. The results are illustrated in FIG. 2.

The space group of this compound was FM-3M.

The half-width in 2θ for the (200) diffraction peak in XRD of the compound was 0.2°.

The compound was then analyzed for its composition by ICP emission spectrometry and inert gas fusion-infrared absorptiometry.

The composition of the compound was determined to be Li_{1.2}Mn_{0.6}Nb_{0.2}O₂.

### Comparative Examples 2 and 3

The precursors were changed from those in Comparative Example 1.

The precursors from which the cathode active materials of Comparative Examples 2 and 3 were produced are summarized in Table.

Except for this, the same procedure as in Comparative Example 1 was repeated to synthesize the cathode active materials of Comparative Examples 2 and 3.

Similar to those in Comparative Example 1, the precursors in Comparative Examples 2 and 3 were weighed out and mixed in stoichiometric amounts.

Both of the compounds obtained as the cathode active materials of Comparative Examples 2 and 3 were in space group FM-3M.

Coin-shaped batteries of Comparative Examples 2 and 3 were produced using the cathode active materials of Comparative Examples 2 and 3 in the same way as in Example 1.

### Comparative Example 4

A LiNiO₂ of space group R3-M was synthesized through a known process.

This LiNiO₂ was used as the precursor.

Except for this, the same procedure as in Example 6 was followed to synthesize the cathode active material of Comparative Example 4.

The compound obtained as the cathode active material of Comparative Example 4 was in space group FM-3M.

A coin-shaped battery of Comparative Example 4 was produced using the cathode active material of Comparative Example 4 in the same way as in Example 1

### Evaluation of the Batteries

The battery of Example 1 was charged to a voltage of 5.2 V with the cathodic current density set to 1.0 mA/cm².

The battery of Example 1 was then discharged at a current density of 1.0 mA/cm² to a termination voltage of 1.5 V.

The initial discharge capacity of the battery of Example 1 was 284 mAh/g.

The battery of Comparative Example 1 was charged to a voltage of 5.2 V with the cathodic current density set to 1.0 mA/cm².

The battery of Comparative Example 1 was then discharged at a current density of 1.0 mA/cm² to a termination voltage of 1.5 V.

The initial discharge capacity of the battery of Comparative Example 1 was 220 mAh/g.

The coin-shaped batteries of Examples 2 to 8 and Comparative Examples 2 to 4 were subjected to capacity measurement in the same way as that of Example 1.

The results are summarized in Table.

TABLE

| | | | | | | Initial |
|---|---|---|---|---|---|---|
| | | | (200) | | | discharge |
| | | | diffraction peak | | | capacity |
| Sample | Precursor(s) | Composition | half-width | x + y | x/y | (mAh/g) |
| Example 1 | Li₂O—Mn₂O₃—Nb₂O₅ | Li_{1.2}Mn_{0.6}Nb_{0.2}O₂ | 2.0° | 2.0 | 1.5 | 284 |
| Example 2 | Li₂MnO₃—Mn₂O₃—TiO₂ | Li_{1.2}Mn_{0.6}Ti_{0.2}O₂ | 1.9° | 2.0 | 1.5 | 280 |
| Example 3 | Li₂MnO₃ | Li_{1.33}Mn_{0.67}O₂ | 1.9° | 2.0 | 1.99 | 303 |
| Example 4 | LiNiO₂ | LiNiO₂ | 1.6° | 2.0 | 1 | 150 |
| Example 5 | Li₂O₂—LiNiO₂ | Li_{1.33}Ni_{0.67}O₂ | 1.8° | 2.0 | 1.99 | 184 |
| Example 6 | Li₂O₂—LiCoO₂ | Li_{1.33}Co_{0.67}O₂ | 1.7° | 2.0 | 1.99 | 136 |
| Example 7 | Li₂O₂—LiNiO₂ | Li_{1.33}Ni_{0.67}O₂ | 1.5° | 2.0 | 1.99 | 114 |
| Example 8 | Li₂O₂—LiCoO₂ | Li_{1.33}Co_{0.67}O₂ | 2.2° | 2.0 | 1.99 | 113 |
| Comparative | Li₂CO₃—Mn₂O₃—Nb₂O₅ | Li_{1.2}Mn_{0.6}Nb_{0.2}O₂ | 0.2° | 2.0 | 1.5 | 220 |
| Example 1 | | | | | | |
| Comparative | Li₂CO₃—Mn₂O₃—MnO₂—TiO₂ | Li_{1.2}Mn_{0.6}Ti_{0.2}O₂ | 0.2° | 2.0 | 1.5 | 218 |
| Example 2 | | | | | | |
| Comparative | Li₂CO₃—Mn₂O₃ | Li_{1.33}Mn_{0.67}O₂ | 0.2° | 2.0 | 1.99 | 165 |
| Example 3 | | | | | | |
| Comparative | LiNiO₂ | LiNiO₂ | 0.8° | 2.0 | 1 | 35 |
| Example 4 | | | | | | |

As demonstrated in Table, when batteries of equivalent compositions are compared, the initial discharge capacity was higher for the batteries having a half-width in 2θ for the (200) diffraction peak of 0.9° or more and 2.4° or less.

A possible explanation for this is as follows: When the half-width in 2θ for the (200) diffraction peak is less than 0.9°, the formation of percolation paths for Li ions can be poor. The low initial discharge capacities are attributable to this.

When the half-width in 2θ for the (200) diffraction peak is more than 2.4°, the crystal structure of the compound is inherently unstable and becomes more unstable when Li is removed during charging. In such a case, the initial discharge capacity should be low.

Presumably, advantages similar to those suggested in these results will be afforded even if Me in the composition formula LiₓMe_{y}O₂ is replaced with any element other than those used in Examples or is a solid solution.

Cathode active materials according to the present disclosure can be suitably used as cathode active materials for batteries such as secondary batteries.

What is claimed is:

1. A cathode active material comprising a compound having a crystal structure of space group FM-3M, represented by composition formula (1), and having a half-width in 2θ of 0.9° or more and 2.4° or less for a (200) diffraction peak in powder X-ray diffraction (XRD):
LiₓMe_{y}O₂ (1)
where Me represents one or two or more elements selected from the group consisting of Mn, Nb, Ti, Ni, Co, Fe, Sn, Cu, Mo, Bi, V, and Cr, and
the following conditions are met:
0.5≦x/y≦3.0; and
1.5≦x+y≦2.3.

2. The cathode active material according to claim 1, wherein Me includes Mn.

3. The cathode active material according to claim 1, wherein
the half-width in 2θ for the (200) diffraction peak in XRD is 1.5° or more and 2.2° or less.

4. The cathode active material according to claim 1, wherein 1.5≦x/y≦2.0.

5. The cathode active material according to claim 1, wherein 1.9≦x+y≦2.0.

6. A battery comprising:
a cathode containing a cathode active material;
an anode; and
an electrolyte; wherein the cathode active material contains a compound having a crystal structure of space group FM-3M, represented by composition formula (1), and having a half-width in 2θ of 0.9° or more and 2.4° or less for a (200) diffraction peak in powder
X-ray diffraction (XRD):
LiₓMe_{y}O₂ (1)
where Me represents one or two or more elements selected from the group consisting of Mn, Nb, Ti, Ni, Co, Fe, Sn, Cu, Mo, Bi, V, and Cr, and
the following conditions are met:
0.5≦x/y≦3.0; and
1.5≦x+y≦2.3.

7. The battery according to claim 6, wherein
the cathode has a cathode active material layer containing the cathode active material as a main component thereof.

8. The battery according to claim 6, wherein:
the anode contains an anode active material that has a property of storing and releasing lithium; and
the electrolyte is a nonaqueous liquid electrolyte.
